(19) United States
(12) Patent Application Publication
(10) Pub. No.: US 2011/0284792 A1
(43) Pub. Date: Nov. 24, 2011

(54) STEEL-BASE SINTERING ALLOY HAVING HIGH WEAR-RESISTANCE FOR VALVE SEAT OF ENGINE AND MANUFACTURING METHOD THEREOF, AND VALVE SEAT OF ENGINE

(75) Inventors: Jong Myung Kim, Gunpo (KR); Ki Bum Kim, Ansan (KR); Dong Jin Kang, Hwaseong (KR); Hyung Oh Ban, Yongin (KR); Hong Kil Baek, Gangnam-gu (KR); Won-Seog Koo, Daegu (KR); Jong-Kwan Park, Daegu (KR); Sung-Tae Choi, Daegu (KR)

(73) Assignees: KOREA SINTERED METAL CO., LTD., Daegu (KR); HYUNDAI MOTOR COMPANY, Seoul (KR)

(21) Appl. No.: 12/906,471

(22) Filed: Oct. 18, 2010

(30) Foreign Application Priority Data
May 24, 2010 (KR) 10-2010-0048083

(51) Int. Cl. F16K 51/00; B22F 3/12; B22F 3/26; B22F 1/00

(52) U.S. Cl. 251/368; 75/243; 419/32; 419/27

(57) ABSTRACT

The present invention features a steel-base sintering alloy having a high wear-resistance for a valve seat of an engine. In preferred embodiments, the steel-base sintering alloy may include a chief element of Ferrum (Fe); and a powder-alloy which are composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

### CROSS-REFERENCE TO RELATED APPLICATION

The present application claims under 35 U.S.C. §119(a) the benefit of Korean Patent Application Number 10-2010-0048083, filed on May 24, 2010, the entire contents of which are incorporated herein by reference.

### BACKGROUND OF THE INVENTION

1. Field of the Invention

The present invention relates to a steel-base sintering alloy having a high wear-resistance for a valve seat of an engine, and a manufacturing method thereof. More particularly, the present invention relates to a steel-base sintering alloy and a manufacturing method thereof, wherein the steel-base sintering alloy may preferably have a high wear-resistance by using a steel-base powder as a matrix, in which Chrome (Cr), Molybdenum (Mo), or the like, is alloyed in the steel-base powder.

In further embodiments, the present invention relates to a valve seat of an engine which is made of the steel-base sintering alloy.

2. Description of Prior Art

In general, a valve seat of an engine in a vehicle is an important component which is indented in a cylinder head, where it plays a role in increasing heat efficiency in a combustion chamber by maintaining the seal of an intake valve or an exhaust valve in opening or closing the valves.

Since the valve seat is repeatedly contacted with the valve and is exposed to harsh conditions where a high temperature due to explosive combustion of fuel is continuously maintained, wear-resistance, impact-resistance, heat-resistance, or the like, are required in the valve seat, more so than another part.

In order to manufacture the valve seat, an infiltration method, a method of adding hard particles, a method of controlling alloy composition, and the like, have been used.

As a vehicle fuel, lead gasoline containing a component of Lead (Pb) has been conventionally used, but, recently, lead-free gasoline has been compulsorily used since lead gasoline can contribute to pollution problems, or the like. Further, as an engine becomes manufactured to a high performance, a high power and a gasoline direct injection (GDI), the valve seat must be suited to excellent performance as well.

On the other hand, in an engine using a gas fuel such as a liquefied petroleum gas (LPG), a compressed natural gas (CNG) or the like, it has been difficult to practically expect a solid lubricity between a valve and a valve seat by products of combustion, the solid lubricity was produced when a liquid fuel such as a gasoline or a diesel was used. Accordingly, the wear of the valve seat tends to increase since metal contact between the valve and the valve seat easily occurs. In this situation, the valve seat for the gas fuel engine needs to have improved wear-resistance even more.

Accordingly, in order to improve the wear-resistance of the valve seat, a method for dispersing an Fe—Cr based hard particle, a Fe—Mo based hard particle, a carbide based hard particle, or the like, into a matrix of the valve seat had previously been used. However, when the dispersion amount of the hard particles becomes too great, the wear of the corresponding object, that is, the wear of the valve was increased.

Accordingly, there remains a need in the art for a steel-base sintering alloy having a high wear-resistance for a valve seat of an engine.

The above information disclosed in this the Background section is only for enhancement of understanding of the background of the invention and therefore it may contain information that does not form the prior art that is already known in this country to a person of ordinary skill in the art.

### BRIEF SUMMARY OF THE INVENTION

The present invention provides a steel-base sintering alloy having a high wear-resistance for a valve seat of an engine and a manufacturing method thereof. According to preferred embodiments, the steel-base sintering alloy of the present invention may maximally decrease a wear amount of a valve, and increase its own wear-resistance.

In other preferred embodiments, the present invention provides a valve seat of an engine having an excellent wear-resistance.

In certain preferred embodiments, a steel-base sintering alloy having a high wear-resistance for a valve seat of an engine may be provided, the steel-base sintering alloy comprising a chief element of Ferrum (Fe); and a powder-alloy which are composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

In another preferred embodiment of the present invention, the steel-base sintering alloy preferably includes a Matrix formed by mixing an alloyed component into Carbon (C) of 0.2˜0.3 wt %, Nickel (Ni) of 1.0˜3.0 wt % and Cobalt (Co) of 1.0˜3.0 wt %, in which the alloyed component is composed of Chrome (Cr) of 0.8˜1.2 wt %, Molybdenum (Mo) of 0.4˜0.6 wt %, Manganese (Mn) of 0.5˜0.9 wt %, Carbon (C) of 1.0˜1.4 wt %, and Ferrum (Fe) of the remainder.

In further preferred embodiments of the present invention, the steel-base sintering alloy preferably includes hard particles, in which 60 wt % Co-30 wt % Mo-8 wt % Cr among the hard particles uses an intermetallic powder with a size of 60 mesh or less manufactured by a gas injection, and it is mixed with Fe-40 wt % Cr-20 wt % W-10 wt % Co and Fe-60 wt % Mo as other hard particles.

In still further preferred embodiments, the present invention features a method for manufacturing a steel-base sintering alloy having a high wear-resistance for a valve seat of an engine may be provided, the method comprising the steps of: (a) mixing a chief element of Ferrum (Fe) into a powder-alloy composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %, in which the powder-alloy is mixed as a hard particle of 60 wt % Co-30 wt % Mo-8 wt % Cr manufactured by a gas injection; (b) pressing a determined pressure at a room temperature onto the powder-alloy mixed by the (a) step, and forming the powder-alloy to be a green body of a valve seat shape, the green body having a green density over 6.85 g/cc; and (c) sintering the green body formed in the (b) step at 1,130° C.˜1,180° C. in a nitrogen atmosphere.

In another preferred embodiment of the present invention, preferably, after the (c) step is performed, an infiltration process or an annealing process is omitted.

In order to achieve the above-described objective, in another preferred embodiment of the present invention, a valve seat of an engine manufactured by the manufacturing method may preferably be provided.

As described herein, according to preferred embodiments, the present invention may provide a steel-base sintering alloy having a high wear-resistance for a valve seat of an engine and a manufacturing method thereof, which is capable of maximally decreasing the wear amount of the corresponding object (valve) as well as increasing its own wear-resistance.

Furthermore, the present invention may preferably provide a valve seat of an engine having an excellent wear-resistance.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a perspective view for illustrating a valve seat of an engine manufactured by a manufacturing method according to the present invention.

FIG. 2 is a figure for representing a formation of FIG. 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

As described herein, the present invention includes a steel-base sintering alloy comprising a chief element of Ferrum (Fe); and a powder-alloy comprising Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

In one embodiments, the alloy has a high wear-resistance for a valve seat of an engine.

In another aspect, the invention features a method for manufacturing a steel-base sintering alloy comprising the steps of (a) mixing a chief element of Ferrum (Fe) into a powder-alloy comprising Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %, in which the powder-alloy is mixed as a hard particle of 60 wt % Co-30 wt % Mo-8 wt % Cr manufactured by a gas injection; (b) pressing a determined pressure at a room temperature onto the powder-alloy mixed by the (a) step, and forming the powder-alloy to be a green body of a valve seat shape, the green body having a green density over 6.85 g/cc; and (c) sintering the green body formed in the (b) step at 1,130° C.˜1,180° C. in a nitrogen atmosphere.

Certain preferred embodiments of the present invention will be explained in detail with reference to the accompanying drawings.

According to preferred embodiments, a steel-base sintering alloy having a high wear-resistance for a valve seat of an engine according to the present invention may include a chief element of Ferrum (Fe); and a powder-alloy which are preferably composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

According to preferred exemplary embodiments, the steel-base sintering alloy may preferably include a Matrix formed by mixing an alloyed component into Carbon (C) of 0.2˜0.3 wt %, Nickel (Ni) of 1.0˜3.0 wt % and Cobalt (Co) of 1.0˜3.0 wt %, in which the alloyed component is composed of Chrome (Cr) of 0.8˜1.2 wt %, Molybdenum (Mo) of 0.4˜0.6 wt %, Manganese (Mn) of 0.5˜0.9 wt %, Carbon (C) of 1.0˜1.4 wt %, and Ferrum (Fe) of the remainder.

According to other certain embodiments, the steel-base sintering alloy may preferably include hard particles, in which 60 wt % Co-30 wt % Mo-8 wt % Cr among the hard particles uses an intermetallic powder with a size of 60 mesh or less manufactured by a gas injection, and it is preferably mixed with Fe-40 wt % Cr-20 wt % W-10 wt % Co and Fe-60 wt % Mo as other hard particles.

As described herein, the inventors of the present invention found that the shape of a hard particle of the valve seat was a factor in decreasing the force upon the corresponding object (e.g., the valve). Further, in order to prevent the hard particle from leaving the matrix, the present inventors used 60 wt % Co-30 wt % Mo-8 wt % Cr which was manufacture by a gas injection, so as to form a cobalt-base hard particle into the shape of a sphere, that is mainly added into the hard particle.

According to further exemplary embodiments, a component of Carbon (C) may be suitably acquired by an alloy powder of Fe—Cr—Mo—Mn—C type and a natural graphite powder, and a component of Nickel (Ni) may be suitably acquired by a pure Ni powder.

Further, a component of Cobalt (Co) and a component of Chrome (Cr) may be suitably acquired by a pure Co powder and a powder of Fe—Cr—W—Co type, respectively, and be also acquired by a powder of Co—Mo—Cr type manufactured by a gas injection so as to sphere a shape of a cobalt-base hard particle.

Further, a component of Molybdenum (Mo) may be suitably acquired by ferro-molybdenum type, and a component of Manganese (Mn) may be suitably acquired by MnS, and, a component of Calcium (Ca) may be suitably acquired by a type of CaF₂.

According to one exemplary embodiment, Carbon (C) may be solved into the known matrix so as to suitably strengthen the known matrix, and at the same time, may form a carbide such as Chrome (Cr), Molybdenum (Mo), and the like, to suitably improve the wear-resistance, in which the carbide amounts to 0.6˜1.2 wt % of the total components. Preferably, if Carbon (C) is below 0.6 wt %, it may not acquire the normal effect, and if Carbon (C) is over 1.2 wt %, the security of the known matrix may be suitably deteriorated owing to forming a cementite into the matrix or owing to forming a liquid state in sintering.

In further exemplary embodiments, nickel (Ni) may be solved into the known matrix to suitably improve the strength the heat-resistance. But, if it is below 1 wt %, it may not have an effect on improving the heat-resistance, and if it is over 3 wt %, it may suitably decrease the wear-resistance, as the remaining austenite matrix is locally and excessively distributed.

According to other further exemplary embodiments, cobalt (Co) may be solved into the known matrix and the hard particle to suitably improve the strength and the wear-resistance. Especially, Cobalt (Co) that is included in the hard particles manufactured by a type of the intermetallic powder may protect from wear by suitably increasing the coherence between the known matrix and the hard particle, in which the wear is produced by breakaway of the hard particle.

According to further exemplary embodiments as described herein, chrome (Cr) reacts with Carbon (C) to form a carbide, and accordingly, it is possible to suitably increase the wear-resistance and, at the same time, to improve heat-resistance by being solved into the known matrix.

Further, molybdenum (Mo) may be solved into the known matrix to suitably improve the heat-resistance and the quenching property, and may suitably improve the wear-resistance by forming complex carbide or an intermetallic powder as it is added in a type of Fe—Mo. However, if Molybdenum (Mo) is excessively added, its strength may be suitably decreased. Further, its range needs to be suitably defined within the above-described range since the corresponding valve may be worn.

According to other embodiments, the processes for manufacturing the valve seat of the engine according to the present invention is set forth as follows with reference to the above-described composition.

In a first exemplary embodiment, the powder material is mixed with the final chemical composition described above.

Next, in a further embodiment, the mixed powder was pressed a pressure of 7˜9 ton/cm² at room temperature to suitably manufacture a green body of the valve seat. At this time, by forming the green body to be a green density of the valve seat over 6.85 g/cc, it is preferable that the hard particles of a high hardness, a middle hardness and a low hardness are adequately dispersed into the known matrix.

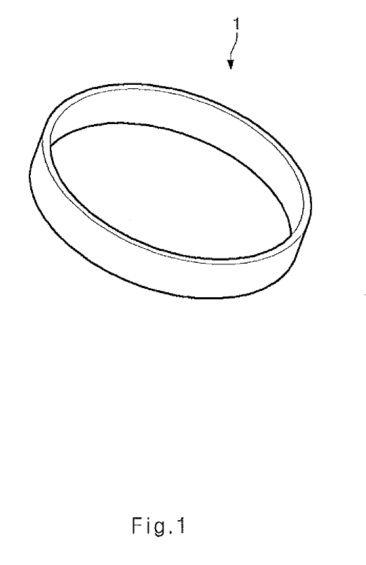

Finally, the formed green body was suitably heated to be sintered at 1,130° C.˜1,180° C. in a nitrogen atmosphere for about 30 minutes˜1.5 hours, and accordingly, the valve seat 1, for example as shown in FIG. 1 was completed. Here, in certain preferred exemplary embodiments, by omitting additional infiltration process or annealing process after the sintering process, the manufacturing cost may be suitably decreased.

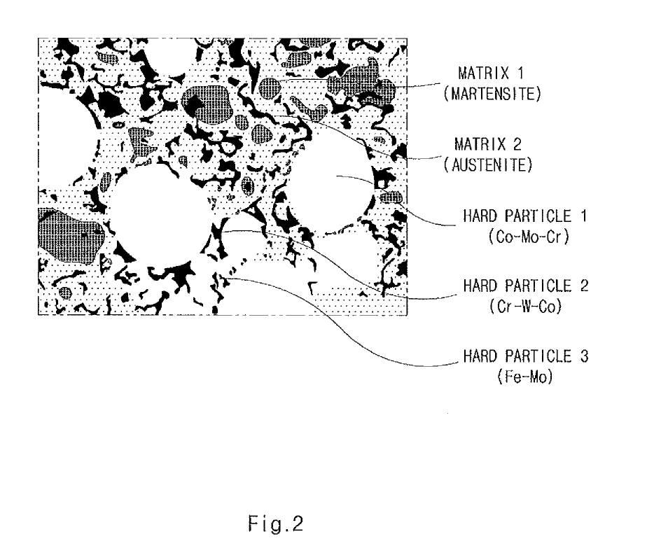

According to further preferred embodiments, and as shown in FIG. 2, for example, the valve seat 1 manufactured by the above-described processes is preferably characterized such that a hard particle of a sphere-shaped intermetallic powder is suitably dispersed into the known matrix which is not annealed. In addition, in further preferred embodiments, the coherence between the known matrix and the hard particle is strengthened due to the diffusion of Cobalt (Co) that is included in the hard particle, and accordingly, it is possible to suitably prevent the hard particle from falling off so as to decrease the total wear amount.

Accordingly, in order to measure the wear amount of the valve seat 1 manufactured by the sintering alloy according to the present invention, after mixing the powder with the contents and the compositions as shown in Table 1, the powder was suitably formed to be a shape of the valve seat 1 by a pressure of 8 ton/cm². And then, it was sintered at 1,150° C. for 49 minutes. Preferably, the sintered body was suitably manufactured to be a shape of the final valve seat 1, and then, the valve seat 1 according to preferred embodiments of the present invention was suitably manufactured through a barrel process. In other certain preferred embodiments, the valve seat 1 according to the comparative examples was copper-infiltrated by the conventional processes, respectively, and then, the valve seat 1 was suitably manufactured by the annealing process or the valve seat 1 was manufactured by the 2P2S process.

TABLE 1

| | | | | | | | | Hard Particle | | | |
|---|---|---|---|---|---|---|---|---|---|---|---|
| | Composition In Matrix (wt %) | | | | | | | | Content | Annealing | |
| Classfication | C | Ni | Cr | Co | Mo | V | Fe | Type | (wt %) | or not | Method |
| Embodiment 1 | 1.0 | 2.0 | 1.0 | — | 0.3 | — | leftovers | A + B + T1 | 40 | x | 1P1S |
| Embodiment 2 | 1.0 | 2.0 | 1.0 | — | 0.3 | — | leftovers | A + B + T1 | 40 | ∘ | 1P1S |
| Embodiment 3 | 1.0 | 2.0 | 1.0 | — | 0.3 | — | leftovers | A + B + T2 | 40 | ∘ | 1P1S |
| Embodiment 4 | 1.0 | 2.0 | 1.0 | — | 0.3 | — | leftovers | A + B + T3 | 40 | ∘ | 1P1S |
| Embodiment 5 | 1.0 | 2.0 | 1.0 | — | 0.3 | — | leftovers | A + B + T1 | 40 | ∘ | Warm |
| | | | | | | | | | | | Forming |
| Embodiment 6 | 1.0 | 2.0 | 1.0 | — | 0.3 | — | leftovers | A + B + T3 | 40 | x | 1P1S |
| Embodiment 7 | 1.0 | 2.0 | 1.0 | — | 0.3 | — | leftovers | A + B + T3 | 40 | ∘ | 1P1S |
| Comparative | 1.2 | 2.0 | — | 6.5 | 1.5 | 1.0 | leftovers | A | 40 | ∘ | Copper |
| Example 1 | | | | | | | | | | | Infiltration |
| Comparative | 0.8 | 1.5 | — | 6.5 | 1.5 | — | leftovers | T1 | 40 | x | 2P2S |
| Example 2 | | | | | | | | | | | |
| Comparative | 1.0 | 5.5 | 3.0 | — | — | — | leftovers | T1 | 40 | x | 2P2S |
| Example 3 | | | | | | | | | | | |

* Hard particle
A: Fe—40 wt % Cr—20 wt % W—10 wt % Co
B: Fe—60 wt % Mo
T1: 60 wt % Co—30 wt % Mo—8 wt % Cr (Manufactured by water injection, Below 200 mesh)
T2: 60 wt % Co—30 wt % Mo—8 wt % Cr (Manufactured by water Injection, Below 100 mesh)
T3: 60 wt % Co—30 wt % Mo—8 wt % Cr (Manufactured by gas Injection, Below 60 mesh)

For each of embodiments and comparative examples of valve seats manufacture by contents and manufacturing methods as shown in Table 1, results as shown in Table 2 were acquired by measuring the wear amount by means of a piece wear/abrasion tester having a shape suitably similar with an actual engine.

The test method according to certain exemplary embodiments of the present invention is as follows; cam revolutions of 1,500 RPM, valve seat temperature of 400° C., and test time of 15 hours.

TABLE 2

| | | | Compressive | | |
|---|---|---|---|---|---|
| | Density | Hardness | Ring Load | Wear Amount (μm) | |
| Classfication | (g/cm³) | (Hv) | (kgf) | Valve Seat | Valve |
| Embodiment 1 | 7.06 | 300 | 207 | 91 | 12 |
| Embodiment 2 | 7.00 | 310 | 108 | 62 | 18 |
| Embodiment 3 | 6.98 | 248 | 105 | 64 | 9 |
| Embodiment 4 | 6.86 | 266 | 68 | 41 | 8 |
| Embodiment 5 | 7.13 | 331 | 134 | 83 | 14 |
| Embodiment 6 | 6.95 | 295 | 55 | 43 | 14 |
| Embodiment 7 | 6.84 | 309 | 20 | 45 | 17 |
| Comparative | 7.78 | 383 | 314 | 240 | 20 |
| Example 1 | | | | | |
| Comparative | 7.12 | 253 | 165 | 120 | 37 |
| Example 2 | | | | | |
| Comparative | 7.25 | 267 | 70 | 50 | 16 |
| Example 3 | | | | | |

As shown in Table 2, it was known that the wear amount of the valve seats according to embodiments of the present invention was averagely decreased by 12%˜63% in comparison with the comparative examples. According to preferred embodiments, in case of the embodiment 6, it showed a good performance in the durability test although the annealing was not performed.

As described herein, according to preferred embodiments, the present invention may have an excellent wear-resistance as materials for the valve seat of the gas fuel engine having the severed combustion conditions and the severed working conditions. Further, although additional processes such as an infiltration process, an annealing process, and the like are not performed, the steel-base sintering alloy of the present invention, is capable of maximally decreasing the wear amount of the corresponding object (valve) as well as increasing its own wear-resistance.

What is claimed is:

1. A steel-base sintering alloy having a high wear-resistance for a valve seat of an engine, the steel-base sintering alloy comprising:
a chief element of Ferrum (Fe); and
a powder-alloy which are composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

2. The steel-base sintering alloy according to claim 1, wherein the alloy additionally comprises a Matrix formed by mixing an alloyed component into Carbon (C) of 0.2˜0.3 wt %, Nickel (Ni) of 1.0˜3.0 wt % and Cobalt (Co) of 1.0˜3.0 wt %, in which the alloyed component is composed of Chrome (Cr) of 0.8˜1.2 wt %, Molybdenum (Mo) of 0.4˜0.6 wt %, Manganese (Mn) of 0.5˜0.9 wt %, Carbon (C) of 1.0˜1.4 wt %, and Ferrum (Fe) of the remainder.

3. The steel-base sintering alloy according to claim 1, wherein, the alloy additionally comprises hard particles, in which 60 wt % Co-30 wt % Mo-8 wt % Cr among the hard particles uses an intermetallic powder with a size of 60 mesh or less manufactured by a gas injection, and it is mixed with Fe-40 wt % Cr-20 wt % W-10 wt % Co and Fe-60 wt % Mo as other hard particles.

4. A method for manufacturing a steel-base sintering alloy having a high wear-resistance for a valve seat of an engine, the method comprising the steps of:
(a) mixing a chief element of Ferrum (Fe) into a powder-alloy composed of Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %, in which the powder-alloy is mixed as a hard particle of 60 wt % Co-30 wt % Mo-8 wt % Cr manufactured by a gas injection;
(b) pressing a determined pressure at a room temperature onto the powder-alloy mixed by the (a) step, and forming the powder-alloy to be a green body of a valve seat shape, the green body having a green density over 6.85 g/cc; and
(c) sintering the green body formed in the (b) step at 1,130° C.˜1,180° C. in a nitrogen atmosphere.

5. The method according to claim 4, wherein, after the (c) step is performed, an infiltration process or an annealing process is omitted.

6. A valve seat of an engine manufactured by the manufacturing method according to claim 5.

7. A steel-base sintering alloy comprising:
a chief element of Ferrum (Fe); and
a powder-alloy comprising Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %.

8. The steel-base sintering alloy of claim 7, wherein the alloy has a high wear-resistance for a valve seat of an engine.

9. A method for manufacturing a steel-base sintering alloy comprising the steps of:
(a) mixing a chief element of Ferrum (Fe) into a powder-alloy comprising Carbon (C) of 0.6˜1.2 wt %, Nickel (Ni) of 1.0˜3.0 wt %, Cobalt (Co) of 15.0˜25.0 wt %, Chrome (Cr) of 3.0˜9.0 wt %, Molybdenum (Mo) of 8.0˜15.0 wt %, Tungsten (W) of 1.0˜4.0 wt %, Manganese (Mn) of 0.5˜2.0 wt %, and Calcium (Ca) of 0.1˜0.5 wt %, in which the powder-alloy is mixed as a hard particle of 60 wt % Co-30 wt % Mo-8 wt % Cr manufactured by a gas injection;
(b) pressing a determined pressure at a room temperature onto the powder-alloy mixed by the (a) step, and forming the powder-alloy to be a green body of a valve seat shape, the green body having a green density over 6.85 g/cc; and
(c) sintering the green body formed in the (b) step at 1,130° C.˜1,180° C. in a nitrogen atmosphere.
